(19) United States
(12) Patent Application Publication
(10) Pub. No.: US 2024/0113423 A1
(43) Pub. Date: Apr. 4, 2024

(54) RF SIGNAL BEAM TRANSMISSION ENHANCEMENT BOARD

(71) Applicant: WKK Mobile Technology Limited, Hong Kong (HK)

(72) Inventors: Wing Hong CHOI, Hong Kong (HK); Bin ZHANG, Hong Kong (HK); Siu Lun LEE, Hong Kong (HK)

(21) Appl. No.: 18/262,385

(22) PCT Filed: Jan. 21, 2022
(86) PCT No.: PCT/CN2022/073238

§ 371 Date: Jul. 21, 2023

Related U.S. Application Data
(60) Provisional application No. 63/140,296, filed on Jan. 22, 2021.

(51) Int. Cl. H01Q 1/38; H01Q 21/06

(52) U.S. Cl. CPC H01Q 1/38; H01Q 21/061

(57) ABSTRACT

A RF signal beam transmission enhancement board comprising: a substrate having at least one substrate surface; at least one elemental-featuring layer disposed on the substrate surface and including a plurality of elemental-featuring elements; and at least one index-matching layer arranged to cover the elemental-featuring elements and the substrate surface. The plurality of elemental-featuring elements has a pattern arrangement with a pattern resolution Rp given by

$$Rp = \frac{λ}{N} ,$$

where λ is a wavelength of a signal beam to be transmitted and N is an integer ranging from 1 to 10 such that the index-matching layer can work with the elemental-featuring elements to form an elemental-surface for minimizing reflection of a signal beam to be transmitted through the signal beam transmission enhancement board.

### CROSS-REFERENCE TO RELATED APPLICATIONS

The present application is a National Phase Entry application of the International Patent Application No. PCT/CN2022/073238 filed on 21 Jan. 2022, which claims priority from the U.S. Provisional Patent Application No. 63/140,296 filed on 22 Jan. 2021, and disclosures of which are incorporated herein by reference in their entireties.

### FIELD OF THE INVENTION

The present invention generally relates to building construction or decoration. More specifically, the present invention relates to a radio frequency (RF) signal beam transmission enhancement board used in building construction or decoration.

### BACKGROUND OF THE INVENTION

Wireless signals such as light waves and RF waves including millimeter waves (mmWave) are difficult to penetrate throughout obstacles in buildings such as concrete walls or severely attenuated even after entering into the building through windows as they can be easily reflected or absorbed by the obstacles. Signal transmission is therefore reduced. To improve wireless signal penetration, one conventional method is to build up thousands of mini-cell tower or base stations for boosting up the signal coverage. However, this method typically costs billions of dollars, which involves of expensive devices and complicated installation process. Therefore, there is a need for a simple and low-cost solution to enhance wireless signal penetration through obstacles, especially for RF signal beams with wavelengths ranging from 666 mm to 7.5 mm (i.e., frequencies ranging from 0.45 GHz to 40 GHz).

### SUMMARY OF THE INVENTION

In accordance with one aspect of the present disclosure, a RF signal beam transmission enhancement board with single-sided configuration is provided. The single-sided signal beam transmission enhancement board comprises: a substrate having at least one substrate surface; at least one elemental-featuring layer disposed on the substrate surface and including a plurality of elemental-featuring elements; and at least one index-matching layer arranged to cover the elemental-featuring elements and the substrate surface. The plurality of elemental-featuring elements has a pattern arrangement with a pattern resolution Rp given by Rp=λ/N, where λ is a wavelength of a signal beam to be transmitted and N is an integer ranging from 1 to 10 such that the index-matching layer can work with the elemental-featuring elements to form a elemental-surface for minimizing reflection of a signal beam to be transmitted through the signal beam transmission enhancement board.

In accordance with another aspect of the present disclosure, a RF signal beam transmission enhancement board with double-sided configuration is provided. The double-sided signal beam transmission enhancement board comprises: a substrate having a first substrate surface and a second substrate surface opposite to the first substrate surface; a first elemental-featuring layer disposed on the first substrate surface and including a plurality of first elemental-featuring elements; a first index-matching layer arranged to cover the first elemental-featuring elements and the first substrate surface; a second elemental-featuring layer disposed on the second substrate surface and including a plurality of second elemental-featuring elements; a second index-matching layer arranged to cover the second elemental-featuring elements and the second substrate surface. The plurality of first elemental-featuring elements has a first pattern arrangement and the plurality of second elemental-featuring elements has a second pattern arrangement. The first and second pattern arrangement have a same pattern resolution Rp given by

$$Rp = \frac{λ}{N} ,$$

where λ is a wavelength of a signal beam to be transmitted and N is an integer ranging from 1 to 10 such that the first and second index-matching layers can work with first elemental-featuring elements and the second elemental-featuring elements to form a double-layered elemental-surface for minimizing reflection of a signal beam to be transmitted through the signal beam transmission enhancement board.

Every elemental-featuring element operates as subwavelength scatterers to exploit modulation of geometric or propagation phase of RF signal beams so that wavefront of an incident wave can be reshaped depending on the direction of polarization of the incident wavelength. Therefore, the provided beam transmission enhancement board can be fixed or attached on obstacles such as windows of a building to provide a simple and low-cost solution for improving signal penetration through the obstacles.

### BRIEF DESCRIPTION OF THE DRAWINGS

Aspects of the present disclosure may be readily understood from the following detailed description with reference to the accompanying figures. The illustrations may not necessarily be drawn to scale. That is, the dimensions of the various features may be arbitrarily increased or reduced for clarity of discussion. There may be distinctions between the artistic renditions in the present disclosure and the actual apparatus due to manufacturing processes and tolerances. Common reference numerals may be used throughout the drawings and the detailed description to indicate the same or similar components.

FIGS. 1A and 1B are cross sectional view of a RF signal beam transmission enhancement board with a single-sided configuration according to one embodiment of the present invention;

FIG. 2 is a cross sectional view of a RF signal beam transmission enhancement board with a single-sided configuration according to one embodiment of the present invention;

FIG. 3 is a cross sectional view of a RF signal beam transmission enhancement board with a single-sided configuration according to one embodiment of the present invention;

FIG. 4 is a cross sectional view of a multi-layered RF signal beam transmission enhancement board according to one embodiment of the present invention;

FIGS. 5A and 5B are cross sectional view of a RF signal beam transmission enhancement board with a double-sided configuration according to another embodiment of the present invention;

FIG. 6A-6C show various exemplary pattern arrangements of the plurality of elemental-featuring elements according to various embodiments of the present invention;

FIG. 7A-7C show various exemplary pattern arrangements of the plurality of elemental-featuring elements according to various embodiments of the present invention;

FIG. 8A-8C show various exemplary pattern arrangements of the plurality of elemental-featuring elements according to various embodiments of the present invention; and

FIG. 9A-9C show various exemplary pattern arrangements of the plurality of elemental-featuring elements according to various embodiments of the present invention.

### DETAILED DESCRIPTION

In the following description, preferred examples of the present disclosure will be set forth as embodiments which are to be regarded as illustrative rather than restrictive. Specific details may be omitted so as not to obscure the present disclosure; however, the disclosure is written to enable one skilled in the art to practice the teachings herein without undue experimentation.

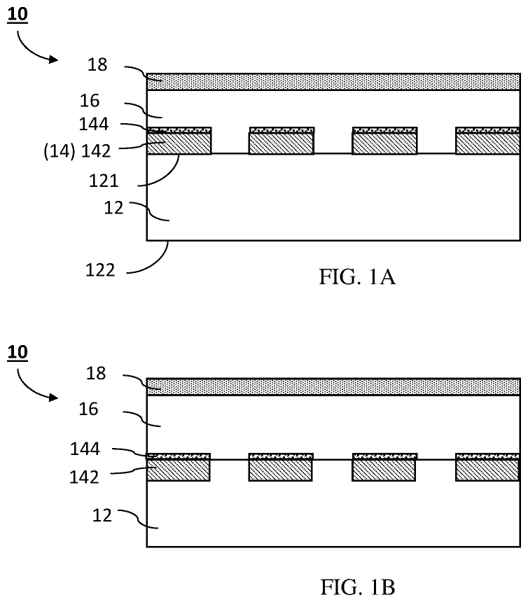

FIG. 1A is a cross-sectional view of a RF signal beam transmission enhancement board 10 with a single-sided configuration according to one embodiment of the present invention. Referring to FIG. 1A, the signal beam transmission enhancement board 10 may comprise a substrate having a first surface 121 and a second surface 122 opposite to the first surface 121.

The signal beam transmission enhancement board 10 may further comprise a elemental-featuring layer 14 disposed on the first surface 121 and including a plurality of elemental-featuring elements 142. Alternatively, the plurality of elemental-featuring elements 142 may be embedded into the first surface 121 of the substrate 12 as shown in FIG. 1B.

The signal beam transmission enhancement board 10 may further comprise an index-matching layer 16 arranged to cover the plurality of elemental-featuring elements 142 and the substrate 12 and configured to work with the elemental-featuring elements 142 to form a elemental-surface for minimizing reflection of a signal beam to be transmitted through the signal beam transmission enhancement board.

Optionally, the signal beam transmission enhancement board 10 may further comprise a plurality of protective layers 144, each arranged on top of a respective elemental-featuring element 142 for protecting the respective elemental-featuring element 142 from corrosion or weathering.

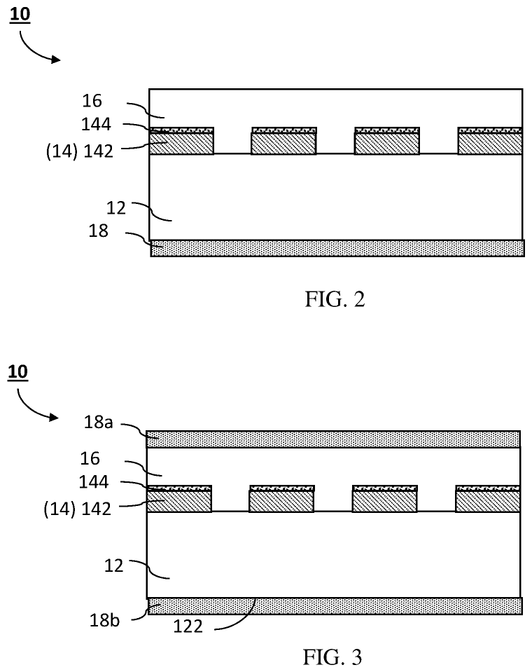

Optionally, the signal beam transmission enhancement board 10 may further comprise an adhesive layer 18 for fixing the signal beam transmission enhancement board 10 onto a surface of an obstacle such as window or concrete wall of a building. Referring to FIG. 1A, the adhesive layer 18 of the signal beam transmission enhancement board 10 may be arranged on the index-matching layer 16. Alternatively, as shown in FIG. 2, the adhesive layer 18 may be arranged on the second substrate surface 122.

In some other embodiments, as shown in FIG. 3, the signal beam transmission enhancement board 10 may comprise a pair of first and second adhesive layer 18a, 18b arranged on the index-matching layer 16 and the second surface 122 of the substrate 12 respectively.

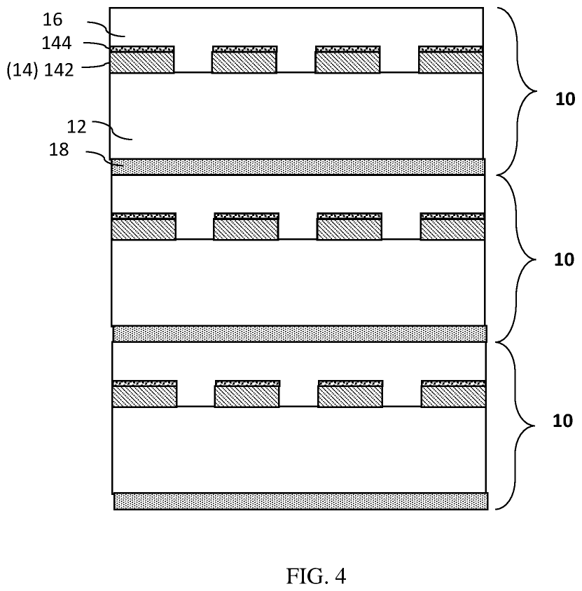

In some other embodiments, as shown in FIG. 4, two or more signal beam transmission enhancement boards 10 may be stacked to form a multi-layered signal beam transmission enhancement board.

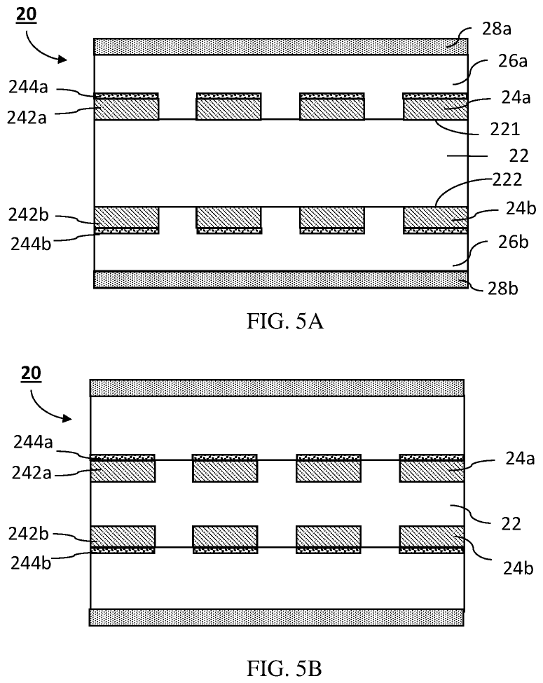

FIG. 5A is a cross-sectional view of a RF signal beam transmission enhancement board 20 with a double-sided configuration according to another embodiment of the present invention. Referring to FIG. 5A, the signal beam transmission enhancement board 20 may comprise a substrate 22 having a first surface 221 and a second surface 222 opposite to the first surface 221. The signal beam transmission enhancement board 20 may further comprise a first elemental-featuring layer 24a disposed on the first surface 221 and including a plurality of first elemental-featuring elements 242a; and a second elemental-featuring layer 24b disposed on the second surface 222 and including a plurality of second elemental-featuring elements 242b. Alternatively, the plurality of first elemental-featuring elements 242a may be embedded into the first surface 221 of the substrate and the plurality of second elemental-featuring elements 242b may be embedded into the second surface 222 of the substrate as shown in FIG. 5B.

The signal beam transmission enhancement board 20 may further comprise a first index-matching layer 26a arranged to cover the plurality of first elemental-featuring elements 242a and the first substrate surface 221; and a second index-matching layer 26b arranged to cover the plurality of second elemental-featuring elements 242b and the second substrate surface 222.

The first and second index-matching layers 26a, 26b may be configured to work with the plurality of first elemental-featuring elements 242a and the plurality of second elemental-featuring elements 242b to form a double-layered elemental-surface for minimizing reflection of a signal beam to be transmitted through the signal beam transmission enhancement board.

Optionally, the signal beam transmission enhancement board 20 may further comprise a plurality of first protective layers 244a disposed on top of the plurality of first elemental-featuring elements 242a respectively; and a plurality of second protective layers 244b disposed on top of the plurality of second elemental-featuring elements 242b respectively.

Optionally, the signal beam transmission enhancement board 20 may further comprise a first adhesive layer 28a disposed on the first indexing matching layer 26a. The first adhesive layer 28a may be configured for fixing the signal beam transmission enhancement board 20 onto a surface of an obstacle such as window and concrete wall of a building. Optionally, the signal beam transmission enhancement board 20 may further comprise a second adhesive layer 28b disposed on the second index-matching layer 26b. As such, the signal beam transmission enhancement board 20 may be used as a bonding film.

In various embodiments, the substrates 12, 22 may have a root mean square surface roughness ranging from 5 nm to 1000 nm so as to enhance the adhesion between the elemental-featuring elements and the substrate, adhesion between the adhesive layer and the substrate and/or adhesion between the index-matching layer and the substrate. The substrates 12, 22 may have a thickness in a range from 10 μm to 100 mm.

In various embodiments, the substrates 12, 22 may be made of a transparent or opaque polymetric material such as, but not limited to, polyethylene terephthalate (PET), polyvinyl chloride (PVC), cyclic olefin copolymer (COC), cyclo olefin polymer (COP), polyethylene naphthalate (PEN), polymethyl methacrylate (PMMA), polyimide (PI), polycarbonate (PC), polyurethane (PU), tantalum carbides (TaC), fiberglass-reinforced epoxy-laminated sheet (FR4), etc., or any other suitable types of polymetric materials which has acceptable transmittance (e.g., more than 60%) for the signal beam to be transmitted.

Alternatively, the substrates 12, 22 may be made of a transparent or opaque non-polymetric material such as, but not limited to, ceramic, glass, silicon, stainless steel (SUS), zinc alloy, aluminum alloy or brass or any other suitable types of non-polymetric materials which has acceptable transmittance (e.g., more than 60%) for the signal beam to be transmitted.

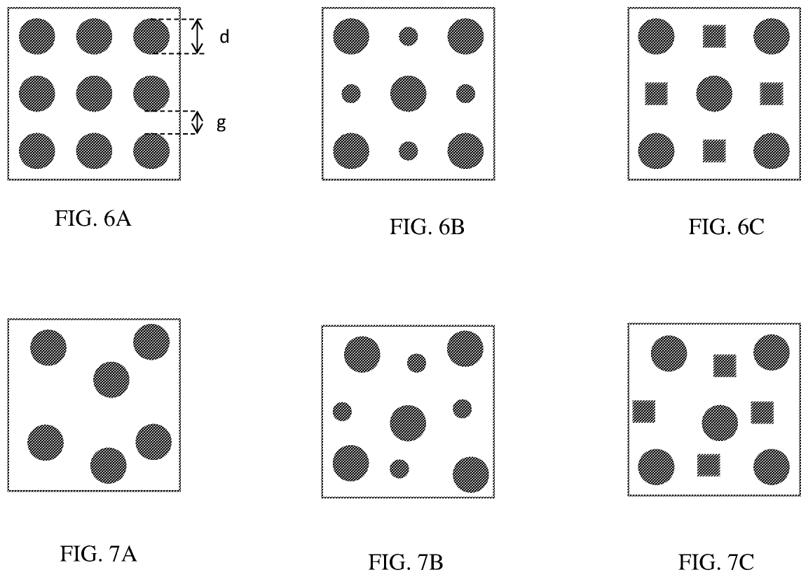

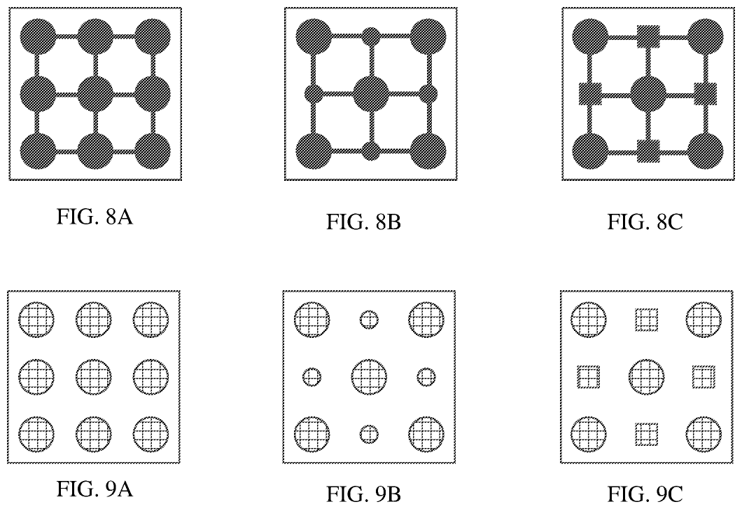

FIGS. 6A-6C, 7A-7C, 8A-8C and 9A-9C show various exemplary pattern arrangements of the plurality of elemental-featuring elements 142, 242a and 242b. The plurality of elemental-featuring elements may have a same shape (e.g., circular shape) and a same size as shown in FIG. 6A. Alternatively, the plurality of elemental-featuring elements may have a same shape but different sizes as shown in FIG. 6B; or have different shapes (e.g., circular shape and square shape) as shown in FIG. 6C. Other exemplary shapes of the elemental-featuring elements may include, but not limited to oval shape, rectangular shape, polygonal shape or ring shape . . . etc. The plurality of elemental-featuring elements 142 may be arranged regularly (e.g., in a two-dimensional array) as shown in FIGS. 6A to 6C or randomly as shown in FIGS. 7A to 7C. The plurality of elemental-featuring elements may be isolated from each other as shown in FIGS. 6A to 6C; or interconnected to each other as shown in FIGS. 8A to 8C. The plurality of elemental-featuring elements may be solidly filled with conductive material as shown in FIGS. 6A to 8C; or filled with conductive material in a meshed form as shown in FIGS. 9A-9C.

In various embodiments, the pattern arrangement of the plurality of elemental-featuring elements 142, 242a and 242b may have a pattern resolution Rp defined as a function (e.g., an average) of sizes of the plurality of elemental-featuring elements or gaps between the plurality of elemental-featuring elements. For example, for the pattern arrangement in which the elemental-featuring elements are in circular shape with same size and regularly arranged as shown in FIG. 6A, a pattern resolution Rp may be defined as an average of a diameter d of the elemental-featuring elements and a gap g between the elemental-featuring elements, that is given by: Rp=(d+g)/2. Alternatively, the pattern resolution Rp may be defined as a sum of a diameter d of the elemental-featuring elements and a gap g between the elemental-featuring elements, that is given by: Rp=d+g.

Preferably, the pattern resolution Rp may be given by

$$Rp = \frac{λ}{N} ,$$

where λ is a wavelength λ of the signal beam to be transmitted and N is an integer ranging from 1 to 10 (i.e., N=1, 2, . . . , 10). The pattern resolution may be selected to range from 500 nm to 100 mm such that the wavelengths of the signal beams to be transmitted may range from 7.5 mm to 666 mm. For example, for enhancing transmission of signal beams with wavelength of 11.5 mm (i.e., at frequency 26 GHz), the pattern resolution may be selected to range from 1.15 mm to 11.5 mm.

In various embodiments the signal beam transmission enhancement board 10, 20 may have an overall thickness t given by

$$t = \frac{λ}{M}$$

where λ is the wavelength of the signal beam to be transmitted and M is an integer ranging from 1 to 10 (i.e., M=1, 2, . . . , 10). The overall thickness t of the signal beam transmission enhancement board may be selected to range from 500 nm to 100 mm such that the wavelengths of the signal beams to be transmitted may range from 7.5 mm to 600 mm. For example, for enhancing transmission of signal beams with wavelength of 11.5 mm (i.e., at frequency 26 GHz), the pattern resolution may be selected to range from 1.15 mm to 11.5 mm.

In various embodiments, the plurality of elemental-featuring elements 142, 242a and 242b may be made of a transparent or opaque conductive material. The conductive material may include: a metal such as, but not limited to, copper, nickel, gold, silver, tin, zinc, chromium, titanium, cobalt, molybdenum, aluminum, platinum or palladium, etc., or an alloy of the metal; a metal oxide such as, but not limited to, indium tin oxide (ITO), indium zinc oxide (IZO), aluminum zinc oxide (AZO), zinc oxide (ZnO), fluorine-doped tin oxide (FTO), Ga-Al-Zn-Oxide (GAZO); a metal nitride such as, but not limited to, titanium nitride (TiN) or tantalum nitride (TaN); or an organic/polymeric material such as, but not limited to, poly(3,4-ethylenedioxythiophene) polystyrene sulfonate (PEDOT:PSS), carbon nanotube (CNT), silver nano-wires (AGNWs), graphene, etc.

In various embodiments, the index-matching layers 16, 26a and 26b may be transparent and have a refraction index with a magnitude ranging from 1 to 3. Preferably, the index-matching layers 16, 26a and 26b may be transparent and have a refraction index with a magnitude ranging from 1.3 to 1.6.

Preferably, the index-matching layers 16, 26a and 26b may have a dielectric constant ranging from 2.0 to 5.0. The index-matching layers 16, 26a and 26b may be made of a low loss material such as, but not limited to, polystyrene, parylene, polyimide, SLA resin, SU-8, SUEX, Cyclic olefin polymers (COP), Polytetrafluoroethylene (PTFE, Liquid crystal polymers (LCP) etc.

Alternatively, the index-matching layers 16, 26a and 26b may be made of a blending material such that the index-matching layers 16, 26a and 26b can also act as an adhesive layer. The blending material may include, but not limited to, copolymers or polymer/ceramic blending, epoxy polymer blending, silicone-based polymer blending etc.

In various embodiments, the protective layers 144, 244a and 244b may be made of conductive resistant materials such as nickel, chromium, titanium, and aluminum, cobalt, molybdenum, platinum, gold, and palladium etc.; or non-conductive resistant materials such as aluminum oxide, chromium oxide, and silicon dioxide. copper oxide, zinc oxide etc.

In various embodiments, the adhesive layers 18, 28a and 28b can be made of an adhesive material such as, but not limited to, acrylic adhesives, epoxy resin, rubber-based adhesives, silicone adhesives, polyurethane and isocyanate adhesives etc.

The embodiments were chosen and described in order to best explain the principles of the invention and its practical application, thereby enabling others skilled in the art to understand the invention for various embodiments and with various modifications that are suited to the particular use contemplated. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations. While the apparatuses disclosed herein have been described with reference to particular structures, shapes, materials, composition of matter and relationships . . . etc., these descriptions and illustrations are not limiting. Modifications may be made to adapt a particular situation to the objective, spirit and scope of the present disclosure. All such modifications are intended to be within the scope of the claims appended hereto.

1. A RF signal beam transmission enhancement board, comprising:
a substrate having at least one substrate surface;
at least one elemental-featuring layer disposed on the substrate surface and including a plurality of elemental-featuring elements; and
at least one index-matching layer arranged to cover the elemental-featuring elements and the substrate surface;
wherein the plurality of elemental-featuring elements has a pattern arrangement with a pattern resolution Rp given by
$$Rp = \frac{λ}{N} ,$$
where λ is a wavelength of a signal beam to be transmitted and N is an integer ranging from 1 to 10, and the index-matching layer is configured to work with the plurality of elemental-featuring elements to form an elemental-surface.

2. The RF signal beam transmission enhancement board according to claim 1, having an overall thickness t given by
$$t = \frac{λ}{M} ,$$
where λ is the wavelength of the signal beam to be transmitted and M is an integer ranging from 1 to 10.

3. The RF signal beam transmission enhancement board according to claim 1, wherein each of the plurality of elemental-featuring elements has at least one of a circular shape, an oval shape, a square shape, a rectangular shape, a polygonal shape and a ring shape.

4. The RF signal beam transmission enhancement board according to claim 1, wherein the plurality of elemental-featuring elements is regularly arranged.

5. The RF signal beam transmission enhancement board according to claim 1, wherein each of the plurality of elemental-featuring elements is solidly filled with a conductive material.

6. The RF signal beam transmission enhancement board according to claim 1, wherein the plurality of elemental-featuring elements are isolated from each other.

7. The RF signal beam transmission enhancement board according to claim 1, further comprising a plurality of protective layers, each disposed on a respective elemental-featuring element.

8. The RF signal beam transmission enhancement board according to claim 1, further comprising at least one adhesive layer deposited on the index-matching layer.

9. The RF signal beam transmission enhancement board according to claim 1, wherein the index-matching layer is further configured to act as an adhesive layer.

10. A RF signal beam transmission enhancement board, comprising:
a substrate having a first substrate surface and a second substrate surface opposite to the first substrate surface;
a first elemental-featuring layer disposed on the first substrate surface and including a plurality of first elemental-featuring elements;
a first index-matching layer arranged to cover the first elemental-featuring elements and the first substrate surface;
a second elemental-featuring layer disposed on the second substrate surface and including a plurality of second elemental-featuring elements; and
a second index-matching layer arranged to cover the second elemental-featuring elements and the second substrate surface;
wherein the plurality of first elemental-featuring elements has a first pattern arrangement and the plurality of second elemental-featuring elements has a second pattern arrangement;
wherein the first and second pattern arrangements have a same pattern resolution Rp given by
$$Rp = \frac{λ}{N} ,$$
where λ is a wavelength of a signal beam to be transmitted and N is an integer ranging from 1 to 10; and
wherein the first and second index-matching layers are configured to work with the plurality of first elemental-featuring elements and the plurality of second elemental-featuring elements to form a double-layered elemental-surface.

11. The RF signal beam transmission enhancement board according to claim 10, having an overall thickness t given by
$$t = \frac{λ}{M} ,$$
where λ is a wavelength of a signal beam to be transmitted and M is an integer ranging from 1 to 10.

12. The RF signal beam transmission enhancement board according to claim 10, wherein each of the plurality of first elemental-featuring elements and the plurality of second elemental-featuring elements has at least one of a circular shape, an oval shape, a square shape, a rectangular shape, a polygonal shape and a ring shape.

13. The RF signal beam transmission enhancement board according to claim 10, wherein the plurality of first elemental-featuring elements and the plurality of second elemental-featuring elements are regularly arranged.

14. The RF signal beam transmission enhancement board according to claim 10, wherein each of the plurality of first elemental-featuring elements and the plurality of second elemental-featuring elements is solidly filled with a conductive material.

15. The RF signal beam transmission enhancement board according to claim 10, wherein the plurality of first elemental-featuring elements and the plurality of second elemental-featuring elements are isolated from each other.

16. The RF signal beam transmission enhancement board according to claim 10, further comprising:
a plurality of first protective layers, each disposed on a respective first elemental-featuring element; and
a plurality of second protective layers, each disposed on a respective second elemental-featuring element.

17. The RF signal beam transmission enhancement board according to claim 10, further comprising:
a first adhesive layer deposited on the first index-matching layer; and
a second adhesive layer deposited on the second index-matching layer.

18. The RF signal beam transmission enhancement board according to claim 10, wherein:
the first index-matching layer is further configured to act as a first adhesive layer; and
the second index-matching layer is further configured to act as a second adhesive layer.
